(19) United States
(12) Patent Application Publication
(10) Pub. No.: US 2005/0019469 A1
(43) Pub. Date: Jan. 27, 2005

(54) Ionization type cooking monitor

(76) Inventors: Joseph Bango, New Haven, CT (US); Michael Dziekan, Naugatuck, CT (US)

Correspondence Address: CONN. ANALYTICAL CORP.;Att: Joseph J. Bango, Jr., 696 AMITY ROAD, BETHANY, CT, 06524, US

(21) Appl. No.: 10/876,910

(22) Filed: Jun. 25, 2004

Related U.S. Application Data
(60) Provisional application No. 60/482,401, filed on Jun. 25, 2003.

(51) Int. Cl. A23C 3/00

(52) U.S. Cl. 426/523

(57) ABSTRACT

This invention makes it possible for an accurate, reliable and repeatable method for determining the amount of “doneness” imparted to bread or bread-like substances when toasting. The ionization sensor reacts to the quantity of carbonaceous material emitted from the food product as it is toasted. Different recipes or compositions of bread or bread-like substances will all contain varying quantities of compounds and moisture that will carbonize differently when heated, as such, the ionization sensor will enable a “true” indication the amount of “doneness” unaffected by composition.

### CROSS REFERENCE TO RELATED APPLICATIONS

Provisional Application No. 60/482401 was filed on 25 Jun. 2003

### BACKGROUND

1. Field of Invention

This invention relates in general to the cooking of food, and in particular to a method of utilizing ionization smoke detector technology in a new way to detect the quantity of emitted particulates produced as a consequence of the application of heat to food products as a means to ascertain predetermined cooking threshold.

2. Background Description of Prior Art

Ever since man first began to apply heat to his food in an effort to translate such food into a form that was more digestible, free of pathogens, easier to masticate, and yielding improved taste, a means of ascertaining when the desired cooking threshold had been achieved has assumed a paramount need. In it's earliest form, determining when food was cooked was arrived at by empirical means, often combining sample tasting of the food to investigation of the internal changes occurring within the food matter as a consequence of the cooking process, generally performed by a combination of cutting and simple observation. Indeed, while most modern techniques consist of internal temperature measurement methods to determine cooking effectiveness, the early approach of empirical testing is still widely employed. Even at present, empirically derived data is often used in combination with specified applied heat levels and a measurement of time, to answer the question of when cooked food is ready for consumption. The process of cooking imparts enough energy to the target food to disrupt the protein molecules in vegetables, meats and seafood, and cause molecular bonds to unwind. Once this occurs, the protein molecules proceed to move about, rapidly bonding in an indiscriminate fashion.

It is this process that results in the changes to color and texture associated with cooked food. During this process, most, if not all, bacteria is destroyed, while most, if not all, viruses are rendered inert. Although cold cooking can be achieved using weak acids, such as that found available in fruits like lemons or limes, most methods of cooking impart thermal energy by radiant or by conductive means. During this exchange of thermal energy, often the food receiving this energy is considered cooked sufficiently for human consumption when the external surface of such food undergoes carbonaceous transformation. In short, as the applied heat remains active over time, some of the food product is consumed as fuel or experiences combustion. Such combustion is defined loosely as a rapid oxidation accompanied by heat, where the fuel so burned is associated with an exothermic reaction which produces carbon particles as a consequence of incomplete combustion of the burning matter. In other words, the incomplete chemical reaction of oxygen with available food fuel yields carbon as a byproduct. Since food is organic by nature, by definition it contains carbon-based molecules.

Very often, when the application of thermal energy to food occurs over a sufficient period of time, the emission of carbonaceous particulates from the surface of such food can be a good indicator of when the food is ready for consumption. While it is theoretically possible for the surface of food to burn whilst the interior of the burned material is sufficiently undercooked, there are food groups which do not present this effect. For example, breads which may be defined as any food derived from baked leavened, kneaded dough made from flour or meal, are often ‘toasted’ in a radiant thermal device. The degree of such ‘toasting’ is empirically determined as light, medium, or dark. Most devices used to transform bread into toast rely on thermal-time dependent mechanisms, which often employ bimetallic elements to deactivate the heating cycle. If a setting that produces desired results for a given thickness sliced bread is used with different thickness bread, an undesired toasted product can result. Efforts to alleviate this condition include humidity sensing apparatus, on the assumption that when moisture outgassing from given heated bread occurs, the cooking cycle should cease.

However, the humidity content varies considerably according to food types and even among identical food product samples. As such, the change in cooking time dependent on moisture content yields uneven results. For example, when using a humidity sensor to determine the cooking of a frozen food, prior art ovens detecting the resulting increase in ambient humidity often malfunction due to the vapor being generated by the premature boiling of residual water due to uneven water distribution in the food product. For example, a potato is particularly vulnerable to fire in a microwave oven due to overcooking since it dries out non-linearly with the core of the potato getting hot before the outer portions. European Patents EP 0 697 802 A2 and EP 0 697 802 A3, both attributed to Kim, offer such a humidity based cooking detection method. A similar humidity sensor for a microwave oven is disclosed in Japanese Patent No. JP 09213475 to Tatsumi and suffers from the same drawbacks discussed in contrast to the disclosed invention, which is not so limited. Other prior art cooking sensors employ detectors for directly determining the temperature of the food being cooked. Despite the advantages offered by the precise detection of the cooking conditions, there are several disadvantages to the temperature sensor directly contacting the food, the paramount being hygiene concerns and the inconvenience of manipulating the sensor into the food. Even if the temperature sensor works perfectly, it is still prone to false indications due to mistakes in user intervention, for example, if the user places a thermal probe in the outer portion of the food to be cooked, then the probe could indicate that the food is cooked, when in actuality the center is still considered “raw” or uncooked. Accordingly, a remote method for sensing the food cooking level is desired and which is irrespective on the initial absolute temperature of the food. Other methods include radiant black body thermal absorption, gaseous vapor emissions, and sensors used to determine food weight changes during the cooking process.

The most basic cooking level detector is designed to determine either the ambient cooking environmental temperature or the internal food temperature. Numerous prior art revelations demonstrate this approach. For example, U.S. Pat. No. 4,059,997 to Trott, describes a meat thermometer for barbecue grills, broilers, or ovens having a stem containing a bimetallic element in one end, with a rotating indicator pointer attached at the other end, indicating the temperature of material into which the stem is inserted. This patent offers no means to determine the cooking level of a food product without direct physical contact. Further, this approach is not suited toward applications involving bread products, since breads are poor conductors of heat and offer a small contact surface area for a temperature sensor element. The disclosed invention is not so limited. U.S. Pat. No. 5,323,730 Ou-Yang, reveals a direct contact thermometer device which is designed to eject a mechanical flag or indicator in a non-reversible manner to indicate when a predetermined temperature-time threshold has been attained. The cited invention requires direct food product physical contact where the disclosed invention does not.

Further, the cited invention cannot be used in applications where a food product exhibits poor thermal conduction, has low moisture content, or a combination of the two—none of which affects the performance of the disclosed invention. Many prior art references offer a means of detecting ambient radiant thermal energy designed to cook a food product, which, combined with time, is employed to verify when a food is sufficiently cooked for consumption. For example, U.S. Patent to Bu, reveals the use of a thermopile to detect the heating process of food products by observing the difference of black body and non-black body heat absorption. This patent references functions according to the fact that the radiation rates of organic and inorganic materials (except metal and glass) are in most cases over 60%.

According to Wien's law, radiation intensity is proportional to the fourth power of the temperature. Utilizing this relationship, several cooking detection methods employ optical detection of absorbed and reflected infrared energy of the food being cooked. However, this method is expensive to implement, and more important, requires a line of sight observation of the food product being cooked to monitor cooking levels. Simple infrared detection suffers similarly. The disclosed invention is both inexpensive and simple to implement and requires only an indirect emitted air sample to effect the cooking monitoring process. A number of prior art references offer a means to determine food cooking levels as a consequence of gaseous emission. U.S. Pat. No. 5,349,163 to Seong-Wan, reveals an automatic cooking detector that senses carbon dioxide or smoke emission from a food during the cooking process. This invention suffers from a lack of complete disclosure in that the gas or smoke sensor is not specifically described either in operation or in the description of any gas other than carbon dioxide, or in the definition of smoke that can be detected. The cited invention therefore is faulty for smoke or particulate detection, describing a result without teaching the means to implement.

Indeed, foods vary considerably in their chemical makeup where gas emissions vary considerably, and therefore is not a reliable cooking indicator. Further, such emissions such as water vapor or steam, oil, or fatty acid aerosol products, can be interpreted as smoke, since such emissions scatter ambient light. Such emissions can also degrade the optical particulate detection devices when condensing on said optical surfaces. The disclosed invention is not limited to food type and is specific in that it responds only to carbonaceous particulate cooking emissions while it is immune to the effects of water vapor and other liquid aerosol products emitted as a consequence of the cooking process. Additional prior art references offer means to detect smoke emissions to determine if a fire in a cooking apparatus may occur. U.S. Pat. No. 4,496,817 to Smith, discloses a means of shutting off a microwave oven when the gaseous emission of a cooked object reaches an empirically predetermined threshold. The Smith invention suffers from a lack of completeness as is the case in U.S. Pat. No. 5,349,163, no definition of smoke is provided, as the disclosed invention offers, and no specific means of detection of carbonaceous combustion products is taught, as does the disclosed invention.

As for specificity regarding gas detection, a Figaro TGS No. 186 gas sensor is cited, being sensitive to water vapor and some organic gases. U.S. Pat. No. 5,493,119 to Tomgren, discloses a means to detect the presence of aerosol particles, such as water vapor and smoke, in the chamber of a microwave oven during the food heating procedure. This method suffers from the fact that an optical detection device is used to detect the cooking level of the food, where the emission of fatty oil aerosol products, water vapor, and particulate matter can contaminate the sensor optical surfaces by condensing on such optics or by diffusing randomly on such optics. The disclosed invention is immune to these effects. No mention is made of employing an ionization type particulate detector as the disclosed invention teaches. U.S. Pat. No. 6,046,441 to Daffron, yields a method of disabling a cooking device to prevent a fire. In the cited invention, a plurality of combustion sensors is employed to detect the emission of carbon dioxide or carbon monoxide if such a cooking device is not properly vented and if the gas emission exceeds a predetermined threshold. This method offers no means to determine the cooking state of the food being prepared, as does the disclosed invention. The cited invention is designed only for the purpose of disabling a cooking device to prevent fire, which is not the intent of the disclosed invention.

### BRIEF DESCRIPTION OF THE DRAWINGS

FIG. 1 illustrates a schematic representation of a typical ionization chamber that would likely be employed in a commercial or residential ionization type smoke detector. The chamber shows only the radiation pattern that would be encountered with no smoke particles or ions.

FIG. 2 provides a schematic representation of the ionization chamber indicating the presence of ions caused by interaction between the ionizing radiation and the air molecules present in the chamber. The ions are causing a small but measurable steady current to be created in the smoke detectors ionization chamber.

FIG. 3 illustrates a schematic representation of the ionization chamber with the introduction of smoke/cooking particles. The smoke/cooking particles cause the ions to collect on them and thereby reduce the amount of available ionization current.

FIG. 4 yields a schematic representation of two pieces of toast that are in the process of being prepared. One piece is lightly toasted, giving off few combustion particles, while the other is heavily toasted, giving off a large quantity of combustion particles. These particles would then enter the ionization chamber to give a quantitative measure of the degree of toast preparedness.

### DETAILED DESCRIPTION OF THE INVENTION

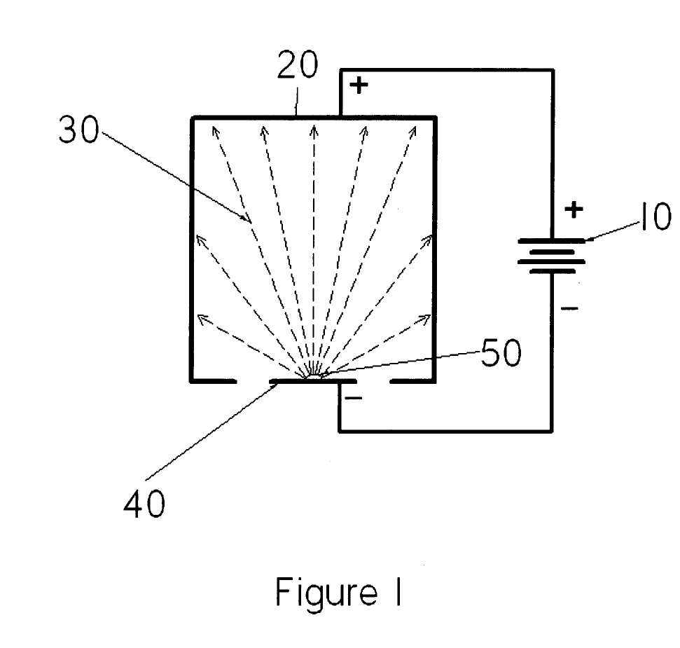

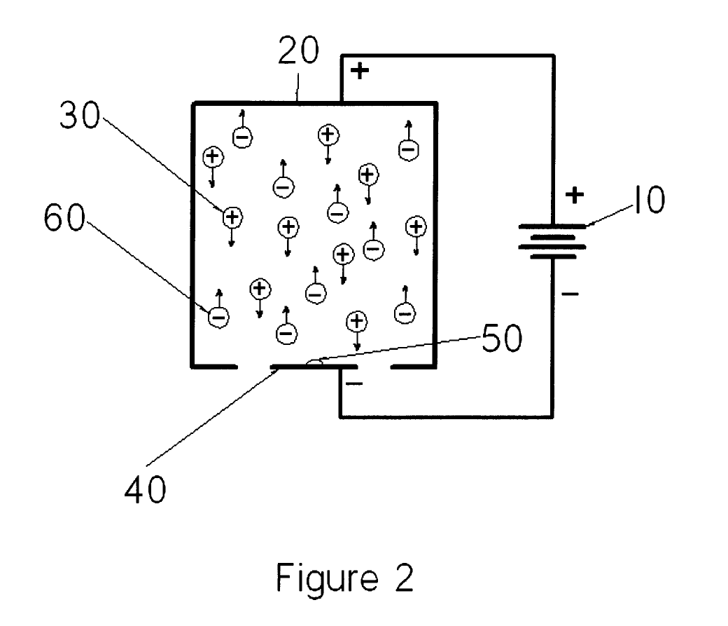

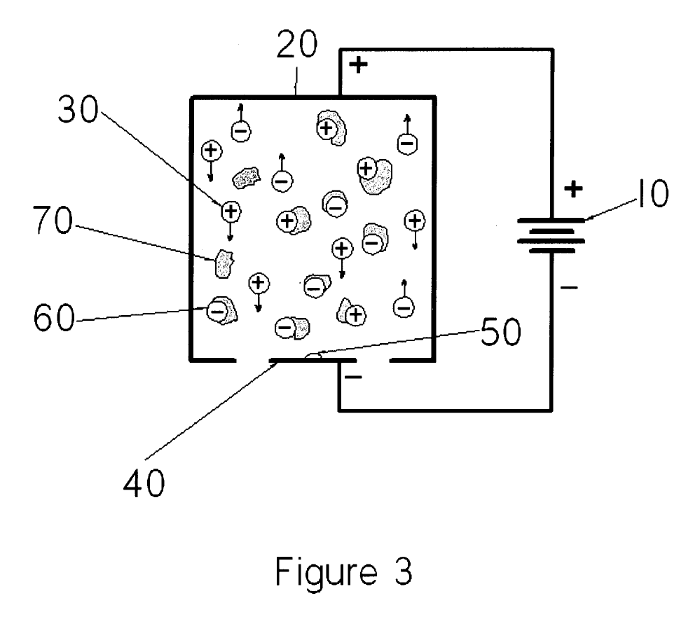

FIG. 1 shows an ionization smoke detectors ionization chamber. A small radioactive source 50 (preferably Americium 241) is placed in a cylindrical metal ionization chamber 20 that confines and directs radioactive particles to interact with ambient air admitted through a small opening, yielding ionized air. A stream of radioactive particles 30 is emitted from the radioactive source 50. A small voltage source 10 is connected to opposing sides of the ionization chamber to create a potential difference across the chamber. There is a positive side 20 and a negative side 40. The two polarities are separated to prevent any short circuit from occurring between the two. FIG. 2 shows that ions of air are produced from the interaction of the ionizing radiation produced by the radioactive source 50. The ions will have a mix of positive 30 and negative 60 ions. Due to the presence of the voltage source 10, there will exist an attraction for the positive 30 ions to be attracted towards the negative plate 40, and an attraction for the negative 60 ions to head towards the positive 20 plate. This attraction will cause a small current to develop (typically picoamps 10⁻¹² amps) and can be measured using preferably a picoammeter or electrometer operational amplifier. The steady presence of current indicates an uninterrupted ion flow; i.e. no smoke or cooking combustion products is present in the detector ionization chamber. FIG. 3 indicates the presence of smoke or cooking combustion products 70 that are introduced into the detector ionization chamber. As large smoke or cooking particles interact with the positive 30 and negative 60 air ions, the total ion flow is decreased, and hence, the current is also decreased. This reduction of current is an indication of the presence and quantity of smoke or cooking combustion products, and a subsequent alarm or warning may be activated based on either the detectors alarm threshold values, or if connected to a fire alarm panel—the fire alarms panels programming alarm threshold values. All current ionization detectors make use of the fact that a reduction of current will indicate the presence of smoke/cooking products. This is because the amount of ionizing radiation inside the chamber produced by the radioactive source 50 does not change normally change with time unless acted upon by some external factor. (It should be noted there would be a slow decrease in emitted ionizing radiation over a period of tens of years, since the half-life for Americium is on the order of 432 years).

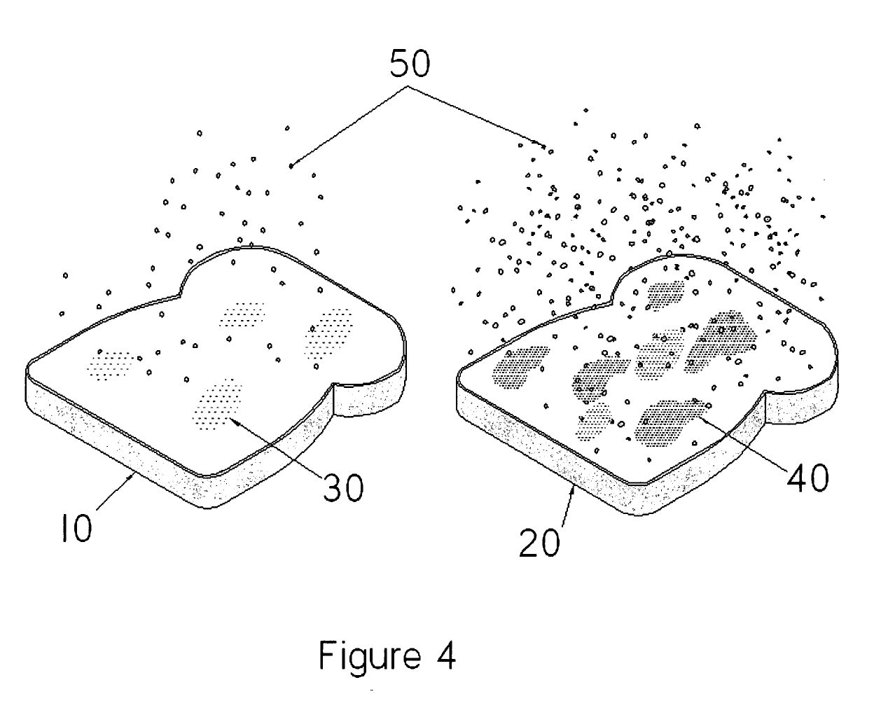

FIG. 4 illustrates the preferred embodiment of the invention. Shown is a food product heated in the process of cooking, in this case two slices of bread, one lightly toasted 10 and one more heavily toasted 20. At a given point, when the cooking activity imparts enough energy to the target food to disrupt the protein molecules, and causes the molecular bonds to unwind, protein molecules proceed to move about rapidly bonding in an indiscriminate fashion, begin outgassing, or participate in combustion. During this exchange of thermal energy, the food receiving this energy is often considered cooked sufficiently for human consumption when the external surface of such food undergoes mild carbonaceous transformation. After a sufficient period of time, the emission of carbonaceous particulates 50 occurs. As the bread slice 10 is toasted, surface discoloration's occur 30 ranging from a light tan, to a dark black. The light tan discoloration equates to a “lightly toasted” piece of bread, while the darker brown or black discoloration equates to a “heavily toasted” or “Dark” slice of toast. In order to produce these surface discolorations, a varied amount of heat must be applied. If the amount of heat is constant, as is the case with nearly every residential and commercial toaster, then the amount of time the slice of bread is kept in the heat must be varied—Dark toast corresponds to a long duration, while light toast corresponds to a shorter duration. The degree of such ‘toasting’ is empirically determined as light, medium, or dark.

It is important to note that most devices currently employed to transform bread into toast rely on thermal-time dependent mechanisms, which often employ bimetallic elements to deactivate the heating cycle. If a setting, which produces desired results for a given thickness sliced bread, is used with different thickness bread, an undesired toasted product can result. Efforts to alleviate this condition include humidity sensing apparatus, on the assumption that when moisture outgassing from given heated bread occurs, the cooking cycle should cease.

As the amount of heat or duration of time spent in the heat is increased, the amount of carbonaceous particles will vary accordingly. A “light” toasting will correspond to a small quantity of carbonaceous particles 50 being released, while a “dark” toasting will correspond to a larger quantity of carbonaceous particles 50 being released. It is this quantitative property that is utilized by the disclosed invention to determine the degree of “light” to “dark” toasting. As the quantity of carbonaceous particles 50 being released, the ionization current will decrease as outlined in FIG. 3. The size and type of food to be cooked can be tailored to an amount of carbonaceous particles being released from the food be it bread, popcorn, muffins, cakes, etc.

Reference Numerals:

FIG. 1:
10 DC Voltage source
20 Metal ionization chamber housing with positive connection to voltage source
30 Particle trail of ionizing radioactive source
40 Metal ionization chamber housing (smaller plate) with negative connection to voltage source
50 Ionizing radioactive source

FIG. 2:
10 DC Voltage source
20 Metal ionization chamber housing with positive connection to voltage source
30 Positive ions of air created by interaction of ionizing radioactive source
40 Metal ionization chamber housing (smaller plate) with negative connection to voltage source
50 Ionizing radioactive source
60 Negative ions of air created by interaction of ionizing radioactive source

FIG. 3:
10 DC Voltage source
20 Metal ionization chamber housing with positive connection to voltage source
30 Positive ions of air created by interaction of ionizing radioactive source
40 Metal ionization chamber housing (smaller plate) with negative connection to voltage source
50 Ionizing radioactive source
60 Negative ions of air created by interaction of ionizing radioactive source
70 Small particles of smoke/combustion particles

FIG. 4:
10 Slice of bread that is lightly toasted due to application of heat
20 Slice of bread that is more heavily toasted due to application of a greater amount/time of heat
30 Regions of light surface browning caused by the toasting process
40 Regions of heavy surface browning caused by the toasting process
50 Small particles of carbonaceous particles due to the toasting process

1. a method of determination of the amount of doneness for a substance that is heated by thermal means based upon response from an ionization type sensing element similar in makeup to an ionization type smoke detector

2. a method of correlation whereby the amount of cooking or doneness of a substance may be determined by equating a specific reduction in ionization current
